(19) United States
(12) Patent Application Publication
(10) Pub. No.: US 2021/0218330 A1
(43) Pub. Date: Jul. 15, 2021

(54) CHARGE PUMP DEVICE AND METHOD FOR PROVIDING PUMP VOLTAGE

(71) Applicant: Winbond Electronics Corp., Taichung City (TW)

(72) Inventor: Koying Huang, San Jose, CA (US)

(73) Assignee: Winbond Electronics Corp., Taichung City (TW)

(21) Appl. No.: 16/739,086

(22) Filed: Jan. 9, 2020

(51) Int. Cl. H02M 3/07

(52) U.S. Cl. CPC H02M 3/07; H02M 2003/072

(57) ABSTRACT

A charge pump device and a method for generating a positive pump voltage or a negative pump voltage are introduced. The charge pump device may include a plurality of pump capacitors, a first switch and a second switch. The plurality of pump capacitors are configured to generate the negative pump voltage or the positive pump voltage. The first switch is coupled between the first power supply line and a first pump capacitor among the plurality of pump capacitors, and is configured to electrically connect the first pump capacitor to the first power supply line to generate the positive pump voltage. The second switch is coupled between the second power supply line and a second pump capacitor among the plurality of pump capacitors, and is configured to electrically connect the second pump capacitor to the second power supply line to generate the negative pump voltage.

### BACKGROUND

### Technical Field

The disclosure generally relates to a charge pump device, and more particularly relates to a method and a charge pump device that may improve the charge pump efficiency and capability.

### Description of Related Art

A charge pump device is used to generate a pump voltage that has a higher voltage level than a power supply voltage. The charge pump device may include a plurality of capacitors that may include P-N junctions. The P-N junctions may cause parasitic capacitance that reduces efficiency and capability of the charge pump device. In addition, the conventional charge pump device is designed to generate either a positive pump voltage or a negative pump voltage. Accordingly, an electronic device that requires the positive pump voltage and the negative pump voltage must include several charge pump devices, resulting in high manufacturing cost.

As a demand for a high-performance charge pump device has grown recently, there has grown a need for a creative design of the charge pump capacitor and a charge pump device that may improve the charge pump efficiency and capability.

Nothing herein should be construed as an admission of knowledge in the prior art of any portion of the present disclosure.

### SUMMARY

A charge pump device and a method for providing a negative pump voltage or a positive pump voltage using the charge pump device are introduced herein.

In some embodiments, the charge pump device may include a plurality of pump capacitors, a first switch and second switch. The plurality of pump capacitors are configured to generate a negative pump voltage or a positive pump voltage. The first switch is coupled between the first power supply line and a first pump capacitor among the plurality of pump capacitors, and is configured to electrically connect the first pump capacitor to the first power supply line to generate the positive pump voltage. The second switch is coupled between the second power supply line and a second pump capacitor among the plurality of pump capacitors, and is configured to electrically connect the second pump capacitor to the second power supply line to generate the negative pump voltage.

In some embodiments, a method of providing a negative pump voltage or a positive pump voltage includes steps of electrically connecting the plurality of pump capacitors in series to generate the positive pump voltage or the negative pump voltage; switching on a first switch to electrically connect a first power supply line to a first pump capacitor among the plurality of pump capacitors to generate the positive pump voltage when the charge pump device is configured to generate the positive pump voltage; and switching on a second switch to electrically connect a second power supply line to a second pump capacitor among the plurality of capacitors to generate the negative pump voltage when the charge pump device is configured to generate the negative pump voltage.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIGS. 1A through 1D are schematic diagrams illustrating charge pump devices in accordance with some embodiments.

FIG. 2 is a cross-sectional view of a pump capacitor in accordance with some embodiments.

FIG. 3A through 3B illustrate a schematic diagram and current-voltage (IV) characteristic of a pump capacitor in accordance with some embodiments.

FIG. 3C through 3D illustrate a schematic diagram and IV characteristic of a pump capacitor in accordance with some alternative embodiments.

FIG. 4 is a flowchart diagram illustrating a method of generating a negative pump voltage or a positive pump voltage adapted to a charge pump device in accordance with some embodiments.

### DESCRIPTION OF THE EMBODIMENTS

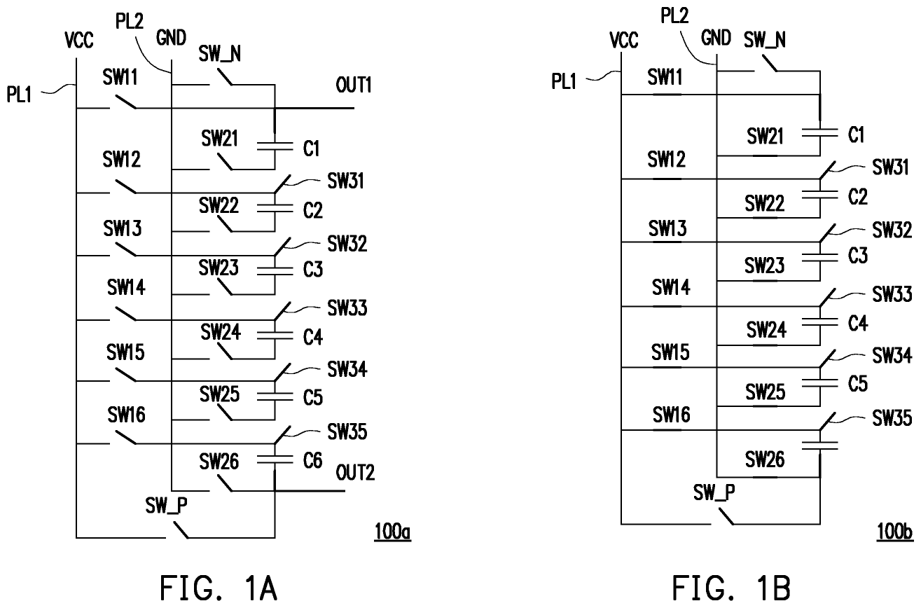

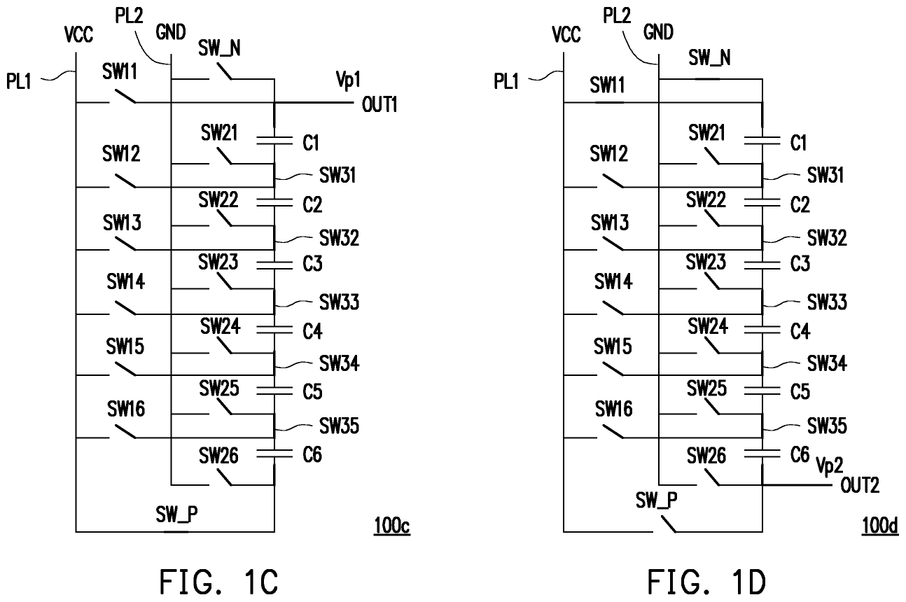

Referring to FIG. 1A, a schematic diagram of a charge pump device 100a is illustrated in accordance with some embodiments. The charge pump device 100a may include a plurality of pump capacitors C1 through C6, and a plurality of switches SW31 through SW35, SW21 through SW26 and SW11 through SW16. The pump capacitors C1 through C6 are coupled to one another through one of the switches SW31 through SW35. More particularly, the pump capacitor C1 is coupled to the pump capacitor C2 via the switch SW31, the pump capacitor C2 is coupled to the pump capacitor C3 via the switch SW32, the pump capacitor C3 is coupled to the pump capacitor C4 via the switch SW33, the pump capacitor C4 is coupled to the pump capacitor C5 via the switch SW34, and the pump capacitor C5 is coupled to the pump capacitor C6 via the switch SW35.

Each of the pump capacitors C1 through C6 has a first terminal and a second terminal, in which the first terminals of the pump capacitors C1 through C6 are coupled to the power supply line PL1 via the switches SW11 through SW16 and the second terminals of the pump capacitors C1 through C6 are coupled to the power supply line PL2 via the switches SW21 through SW26. The power supply line PL1 may receive the power supply voltage VCC and the power supply line PL2 may receive the power supply voltage GND. The switches SW11 through SW16 are configured to control electrical connections between the first terminals of the pump capacitors C1 through C6 and the power supply line PL1. The switches SW21 through SW26 are configured to control electrical connections between the second terminals of the pump capacitors C1 through C6 and the power supply line PL2. In some embodiment, the switches SW11 through SW16, switches SW21 through SW26 and the switches SW31 through SW35 are controlled by switching signals (not shown).

In some embodiments, the charge pump device 100a further includes switches SW_P and SW_N. The switch SW_P is coupled between the second terminal of the pump capacitor C6 and the power supply line PL1, and is configured to control an electrical connection between the second terminal of the pump capacitor C6 and the power supply line PL1. The switch SW_N is coupled between the first terminal of the pump C1 and the power supply line PL2, and is configured to control an electrical connection between the first terminal of the pump C1 and the power supply line PL2. In some embodiments, the charge pump device 100a further includes output terminals OUT1 and OUT2, in which the output terminal OUT1 is coupled to the first terminal of the pump capacitor C1 and the output terminal OUT2 is coupled to the second terminal of the pump capacitor C6. The output terminal OUT1 is configured to output a positive pump voltage, and the output terminal OUT2 is configured to output a negative pump voltage. The voltage levels of the positive pump voltage and the negative pump voltage are greater than the voltage level of the power supply voltage VCC. In some embodiments, the charge pump device 100a may generate the positive pump voltage or the negative pump voltage based on the switching of the switches SW_N and SW_P. For example, the charge pump device 100a may generate and output the positive pump voltage to the output terminal OUT1 when the switch SW_P is switched on and the switch SW_N is switched off. The charge pump device 100a may generate and output the negative pump voltage to the output terminal OUT2 when the switch SW_P is switched off and the switch SW_N is switched on. In other words, the same charge pump device 100a may be used to generate the positive pump voltage in the output terminal OUT1 or the negative pump voltage in the output terminal OUT2. As a result, the functionality and the flexibility of the charge pump device 100 are improved.

In some embodiments, the charge pump device 100a may include a first stage and a second stage, in which the pump capacitors C1 through C6 are charged in the first stage and the pump capacitors C1 through C6 are configured to generate the negative pump voltage or the positive pump voltage in the second stage.

Referring to FIG. 1B, a charge pump device 100b that is in the first stage is illustrated in accordance with some embodiments. The same elements of the charge pump device 100b in FIG. 1B and the charge pump device 100a in FIG. 1A are numbered with the same reference numbers. During the first stage of the charge pump device 100b, the switches SW31 through SW35 and the switches SW_P and SW_N are switched off, thereby disconnecting the electrical connections among the pump capacitors C1 through C6. Meanwhile, the switches SW11 through SW16 and the switches SW21 through SW26 are switched on to form electrical connections between the pump capacitors C1 through C6 and the power supply lines PL1 and PL2. The first terminal of each of the pump capacitors C1 through C6 is electrically connected to the power supply line PL1, and the second terminal of each of the pump capacitors C1 through C6 is electrically connected to the power supply line PL2. As such, the pump capacitors C1 through C6 are coupled in parallel in the first stage. Each of the pump capacitors C1 through C6 is charged to a predetermined voltage level in the first stage. In some embodiments, the predetermined voltage level may be the voltage level of the power supply voltage VCC, but the disclosure is not limited thereto. In some embodiments, the time period of the first stage is set such that each of the capacitors C1 through C6 is charged to the predetermined voltage level.

Referring to FIG. 1C, a charge pump device 100c that is configured to generate the positive pump voltage Vp1 in the second stage is illustrated in accordance with some embodiments. The same elements of the charge pump device 100c in FIG. 1C and the charge pump device 100a in FIG. 1A are numbered with the same reference numbers. In the second stage, the switches SW11 through SW16 and the switches SW21 through SW26 of the charge pump device 100c are switched off and the switches SW31 through SW35 of the charge pump device 100c are switched on to electrically connect the pump capacitors C1 through C6 in series. Meanwhile, the switch SW_N of the charge pump device 100c is switched off and the switch SW_P of the charge pump device 100c is switched on to electrically connect the second terminal of the pump capacitor C6 to the power supply line PL1. As such, the power supply voltage VCC is supplied to the second terminal of the pump capacitor C6, and the positive pump voltage Vpl is generated and outputted to the output terminal OUT1. The voltage level of the positive pump voltage Vp1 which is greater than the voltage level of the power supply voltage VCC may be determined based on the number of the pump capacitors C1 through C6 and the capacitance values of the capacitors C1 through C6.

Referring to FIG. 1D, a charge pump device 100d that is configured to generate a negative pump voltage Vp2 in the second stage is illustrated in accordance with some embodiments. The same elements of the charge pump device 100d in FIG. 1D and the charge pump device 100a in FIG. 1A are numbered with the same reference numbers. In the second stage, the switches SW11 through SW16 and the switches SW21 through SW26 of the charge pump device 100d are switched off and the switches SW31 through SW35 of the charge pump device 100d are switched on to electrically connect the pump capacitors C1 through C6 in series. Meanwhile, the switch SW_N of the charge pump device 100d is switched on and the switch SW_P of the charge pump device 100d is switched off to electrically connect the first terminal of the pump capacitor C1 to the power supply line PL2. As such, the power supply voltage GND is supplied to the first terminal of the pump capacitor C1, and the negative pump voltage Vp2 is generated and outputted to the output terminal OUT2. The voltage level of the negative pump voltage Vp2 may be determined based on the number of the pump capacitors C1 through C6 and the capacitance values of the capacitors C1 through C6.

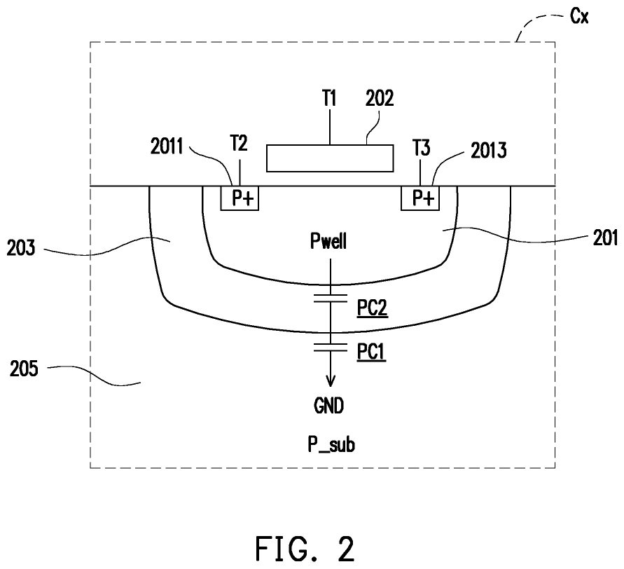

Referring to FIG. 2, a cross-sectional view of a pump capacitor Cx is illustrated in accordance with some embodiments. The pump capacitor Cx may be any one of the pump capacitors C1 through C6 of the charge pump devices in FIG. 1A through FIG. 1D. The pump capacitor Cx may include a substrate 205, a deep well 203, a well 201 and a gate layer 202. In some embodiments, the substrate 205 is a p-type substrate 205, the deep well 203 is a n-type deep well 203, the well 201 is a p-type well 201, but the disclosure is not limited thereto. The semiconductor types of the substrate 205, the deep well 203 and the well 201 may vary based on the designed needs. The pump capacitor Cx may have two terminals, namely a low-side terminal and a high-side terminal, in which the gate layer 202 may be coupled to the low-side terminal of the pump capacitor Cx and the p-type well 201 may be coupled to the high-side terminal of the pump capacitor Cx. The low-side terminal and the high-side terminal of the pump capacitor Cx may vary depending on the semiconductor types of the substrate 205, the deep well 203 and the well 201.

In some embodiments, the p-type well 201 includes p-type doped regions 2011 and 2013 that are coupled to terminals T2 and T3, and the gate layer 202 may be coupled to a terminal T1. The terminals T1 and T3 may be referred to as the low-side terminal and the high-side terminal of the pump capacitor Cx, respectively. In some embodiments, the pump capacitor Cx is a metal-oxide-semiconductor (MOS) transistor that has a structure of a MOS transistor. The MOS structure may include a gate that is coupled to the terminal T1, a drain that is coupled to the terminal T2 and a source that is coupled to the terminal T3.

In some embodiments, the p-type substrate 205 may capacitively couple to the n-type deep well 203, in which a parasitic capacitor PC1 is existed as a result of the P-N junction between the p-type substrate 205 and the n-type deep well 203. The n-type deep well 203 may capacitively couple to the p-type well 201, in which a parasitic capacitor PC2 is existed as a result of the P-N junction between the n-type deep well 203 and the p-type well 201. The parasitic capacitance of the parasitic capacitors PC1 and PC2 may degrade the pump efficiency of the pump capacitor Cx.

In some embodiments, the p-type substrate 205 of the pump capacitor Cx is biased by a reference voltage (e.g., GND) and the n-type deep well 203 is floated. As the n-type deep well 203 is floated, the parasitic capacitor PC1 is coupled to the parasitic capacitor PC2 in series, thereby reducing the equivalent parasitic capacitance of the parasitic capacitors PC1 and PC2. The reduction of the equivalent parasitic capacitance of the parasitic capacitors PC1 and PC2 improves the pump efficiency of the pump capacitor Cx. In other words, by floating the n-type deep well 203, the pump efficiency of the pump capacitor Cx is improved.

In addition, the p-type substrate 205, the n-type deep well 203 and the p-type well 201 may form a PNP transistor (e.g., a bipolar transistor) having a base which is the n-type deep well 203, a collector and an emitter which are the p-type well 201 and the p-type substrate 205. When the n-type deep well 203 is floated, the breakdown voltage (e.g., voltage BVCEO) between the collector and the emitter is relatively high in both of the forward and reverse directions. As such, high voltages may be applied to the p-type well 201 of the pump capacitor Cx in both forward or reverse directions without breaking down the pump capacitor Cx. In other words, a high positive voltage or a high negative voltage may be applied to the p-type well 201 of the pump capacitor Cx. Since both of the high positive voltage and the high negative voltage may be applied to the p-type well 201 of the pump capacitor Cx, the pump capacitor Cx may be used in a charge pump device to generate the positive pump voltage or the negative pump voltage.

Referring to FIG. 1C and FIG. 2, when the charge pump device 100c is configured to generate the positive pump voltage Vp1, the p-type well 201 of the pump capacitors Cx (e.g., pump capacitors C1 through C6) may be applied by high positive voltages. Referring to FIG. 1D and FIG. 2, when the charge pump device 100d is configured to generate the positive pump voltage Vp2, the p-type well 201 of the pump capacitors Cx (e.g., pump capacitors C1 through C6) may be applied by high negative voltages.

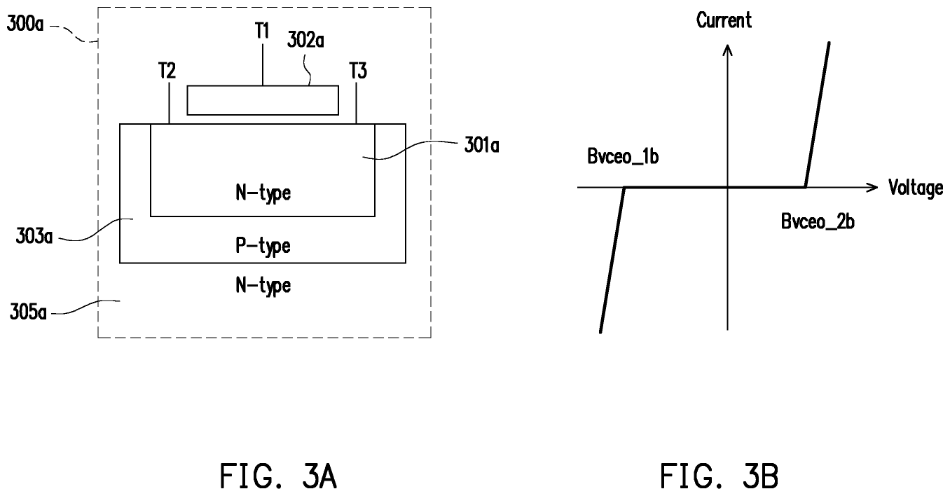

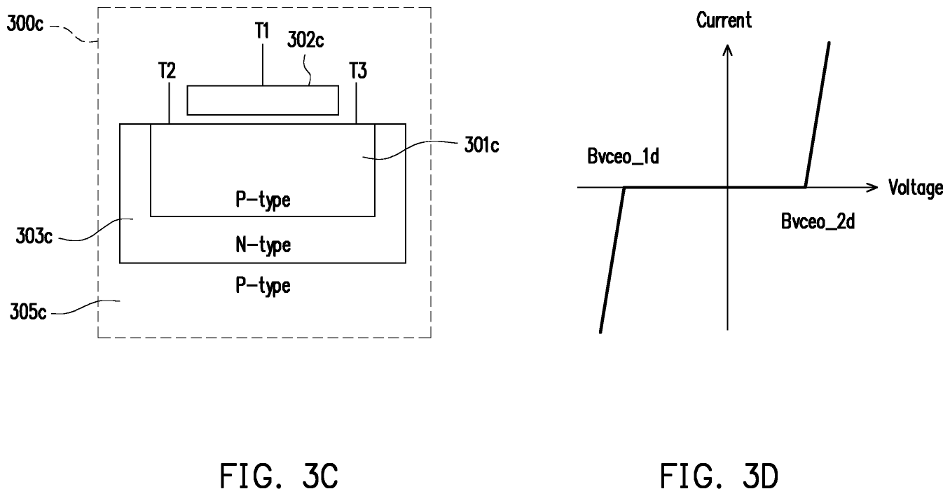

Referring to FIG. 3A, a schematic diagram of a pump capacitor 300a is illustrated in accordance with some embodiments. The pump capacitor 300a may include a n-type substrate 305a, a p-type deep well 303a, a n-type well 301a and a gate layer 302a. The pump capacitor 300a may include two terminals, namely a high-side terminal and a low-side terminal, in which the low-side terminal of the pump capacitor 300a may be coupled to the n-type well 301a and the high-side terminal of the pump capacitor 300a may be coupled to the gate layer 302a. In some embodiments, the high-side terminal of the pump capacitor 300a is coupled to the terminal T1, and the low-side terminal of the pump capacitor 300a is coupled to the terminal T3.

The n-type substrate 305a, the p-type deep well 303a and the n-type well 301a may form a NPN transistor (e.g., a bipolar transistor) having a base which is the p-type deep well 303a, a collector and an emitter which are n-type substrate 305a and n-type well 301a. In some embodiments, the p-type deep well 303a is floated. When the p-type deep well 303a is floated, the breakdown voltage (e.g., voltage BVCEO) between the collector and the emitter is relatively high in both of the forward and reverse directions.

Referring to FIG. 3B, the IV characteristic of the NPN transistor that is formed by the n-type substrate 305a, the p-type deep well 303a and the n-type well 301a in FIG. 3A is illustrated in accordance with some embodiments. The horizontal axis in FIG. 3B illustrates a voltage between the collector and the emitter of the NPN transistor when the base of the NPN transistor is floated. The vertical axis in FIG. 3B illustrates a current flowing through the collector and the emitter of the NPN transistor when the base of the NPN transistor is floated. As shown in FIG. 3B, the breakdown voltages Bvceo_1b and Bvceo_2b between the collector and the emitter of the NPN transistor in forward and reverse directions are high. For example, the absolute values of the breakdown voltages Bvceo_1b and Bvceo_2b as shown in FIG. 3B are much higher than a forward bias voltage of the P-N junction. As such, high voltages may be applied to the n-type well 301a of the pump capacitor 300a in both forward or reverse directions without breaking down the pump capacitor 300a. In other words, a high positive voltage or a high negative voltage may be applied to the n-type well 301a of the pump capacitor 300a, allowing the pump capacitor 300a to generate the positive pump voltage or the negative pump voltage.

Referring to FIG. 3C, a schematic diagram of a pump capacitor 300c is illustrated in accordance with some embodiments. The pump capacitor 300c may include a p-type substrate 305c, a n-type deep well 303c, a p-type well 301c and a gate layer 302c. The pump capacitor 300c may include two terminals, namely a high-side terminal and a low-side terminal, in which the low-side terminal of the pump capacitor 300c may be coupled to the gate layer 302c and the high-side terminal of the pump capacitor 300c may be coupled to the n-type well 301c. In some embodiments, the high-side terminal of the pump capacitor 300c is coupled to the terminal T3, and the low-side terminal of the pump capacitor 300c is coupled to the terminal T1.

The p-type substrate 305c, the n-type deep well 303c and the p-type well 301c may form a PNP transistor having a base which is the n-type deep well 303c, a collector and an emitter which are p-type substrate 305c and p-type well 301c. In some embodiments, the n-type deep well 303c is floated. When the n-type deep well 303c is floated, the breakdown voltage (e.g., voltage BVCEO) between the collector and the emitter is relatively high in both of the forward and reverse directions.

Referring to FIG. 3D, the IV characteristic of the PNP transistor that is formed by the p-type substrate 305c, the n-type deep well 303c and the p-type well 301c in FIG. 3C is illustrated in accordance with some embodiments. The horizontal axis in FIG. 3D illustrates a voltage between the collector and the emitter of the PNP transistor when the base of the PNP transistor is floated. The vertical axis in FIG. 3D illustrates a current flowing through the collector and the emitter of the PNP transistor when the base of the PNP transistor is floated. As shown in FIG. 3D, the breakdown voltages Bvceo_1d and Bvceo_2d between the collector and the emitter of the PNP transistor in forward and reverse biases are high. The absolute values of the breakdown voltages Bvceo_1d and Bvceo_2d may be much greater than a forward bias voltage of the P-N junction. As such, the high negative voltage and the high positive voltage may be applied to the p-type well 301d without breaking down the pump capacitor 300c, allowing the he pump capacitor 300c in FIG. 3C to generate the positive pump voltage or the negative pump voltage.

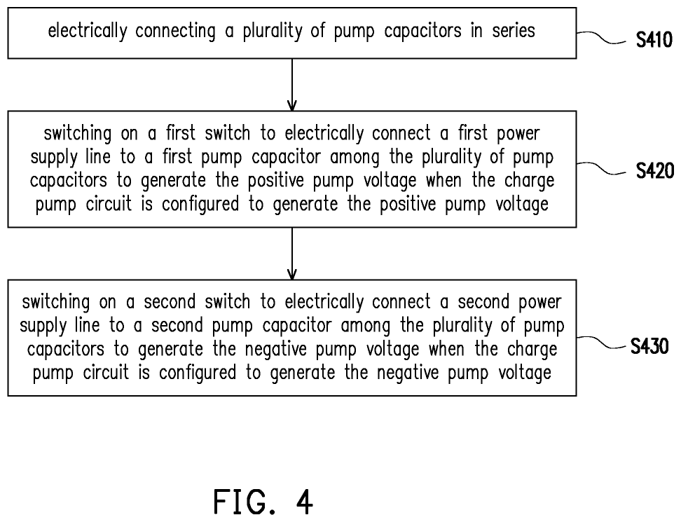

Referring to FIG. 4, a flowchart of a method for generating a negative pump voltage or a positive pump voltage is illustrated in accordance with some embodiments. In step S410, a plurality of pump capacitors is electrically connected the in series. In some embodiments, a charge pump device for generating the negative pump voltage or the positive pump voltage has two stages, namely a first stage and a second stage. The plurality of pump capacitors is electrically connected the in series in the second stage. In step S420, a first switch is switched on to electrically connect a first power supply line to a first pump capacitor among the plurality of pump capacitors to generate the positive pump voltage when the charge pump device is configured to generate the positive pump voltage. In step S430, a second switch is switched on to electrically connect a second power supply line to a second pump capacitor among the plurality of capacitors to generate the negative pump voltage when the charge pump device is configured to generate the negative pump voltage.

In summary, a charge pump device including a plurality of pump capacitors and a method for generating a positive pump voltage or a negative pump voltage are introduced. Each of the pump capacitors may include a substrate of a first semiconductor type, a deep well of a second semiconductor type and a well of the first conductor type. The deep well of the pump capacitors is floated, thereby reducing the equivalent parasitic capacitance among the substrate, the deep well and the well of the pump capacitors and enhancing the pump capability of the pump capacitors. In addition, a high positive voltage or a high negative voltage may be applied to the well of the pump capacitors, thus allowing the same charge pump device to generate the positive pump voltage or the negative pump voltage. As a result, the flexibility of the charge pump device is improved, and the manufacturing cost of electronic devices, specifically the electronic devices that requires positive pump voltage and negative pump voltage, is reduced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A charge pump device, comprising:
a plurality of pump capacitors, configured to generate a negative pump voltage or a positive pump voltage, wherein each of the plurality of pump capacitors comprises a high-side terminal and a low-side terminal;
a first switch, coupled between a first power supply line and a first pump capacitor among the plurality of pump capacitors, configured to electrically connect the first pump capacitor to the first power supply line to generate the positive pump voltage; and
a second switch, coupled between a second power supply line and a second pump capacitor among the plurality of pump capacitors, configured to electrically connect the second pump capacitor to the second power supply line to generate the negative pump voltage,
wherein each of the plurality of pump capacitors comprises:
a substrate of a first semiconductor type, wherein the substrate is biased by a reference voltage;
a first well of a second semiconductor type, capacitively coupled to the substrate, wherein the first well is floated;
a second well of the first semiconductor type, capacitively coupled to the first well, wherein the second well is coupled to the high-side terminal; and
a gate layer, coupled to the low-side end,
wherein the second well of each of the plurality of pump capacitors is applied by a positive voltage when the plurality of pump capacitors are configured to generate the positive pump voltage, and the second well of each of the plurality of pump capacitors is applied by a negative voltage when the plurality of pump capacitors are configured to generate the negative pump voltage.

2-3. (canceled)

4. The charge pump device of claim 1, wherein a first parasitic capacitor that is formed between the substrate and the first well is coupled in series to a second parasitic capacitor that is formed between the first well and the second well.

5. (canceled)

6. The charge pump device of claim 1, wherein the second well comprises a doped region that is coupled to the high-side terminal of each of the plurality of capacitors.

7. The charge pump device of claim 1, wherein
each of the plurality of the pump capacitors is electrically coupled between the first power supply line and the second power supply to charge each of the plurality of the pump capacitors to a predetermined voltage in a first stage, and
the plurality of the pump capacitors are coupled in series to generate the positive pump voltage or the negative pump voltage in a second stage.

8. The charge pump device of claim 7, further comprising:
a plurality of third switches, wherein
each of the plurality of third switches is coupled between two pump capacitors among the plurality of pump capacitors,
the plurality of the third switches are switched off to electrically insulate the plurality of the pump capacitors from one another in the first stage, and
the plurality of the third switches are switched on to electrically connect the plurality of pump capacitors in series in the second stage.

9. The charge pump device of claim 8, further comprising:
a plurality of fourth switches, coupled between the plurality of pump capacitors and the first power supply, wherein
the plurality of fourth switches are switched on to electrically connect the high-side terminal of each of the plurality of pump capacitors to the first power supply line in the first stage, and
the plurality of fourth switches are switched off to electrically insulate the high-side terminal of each of the plurality of pump capacitors from the first power supply line in the second stage.

10. The charge pump device of claim 9, further comprising:
a plurality of fifth switches, coupled between the plurality of pump capacitors and a second supply line, wherein
the plurality of fifth switches are switched on to electrically connect the low-side terminal of each of the plurality of pump capacitors to the second power supply line in the first stage, and
the plurality of fifth switches are switched off to electrically insulate the low-side terminal of each of the plurality of pump capacitors from the second power supply line in the second stage.

11. A method of providing a negative pump voltage or a positive pump voltage adapted to a charge pump device, the method comprising:
electrically connecting the plurality of pump capacitors in series;
switching on a first switch to electrically connect a first power supply line to a first pump capacitor among the plurality of pump capacitors to generate the positive pump voltage when the charge pump device is configured to generate the positive pump voltage; and
switching on a second switch to electrically connect a second power supply line to a second pump capacitor among the plurality of capacitors to generate the negative pump voltage when the charge pump device is configured to generate the negative pump voltage,
wherein each of the plurality of pump capacitors comprises a high-side terminal and a low-side terminal, and wherein each of the plurality of pump capacitors comprises:
a substrate of a first semiconductor type, wherein the substrate is biased by a reference voltage;
a first well of a second semiconductor type, capacitively coupled to the substrate, wherein the first well is floated;
a second well of the first semiconductor type, capacitively coupled to the first well, wherein the second well is coupled to the high-side terminal; and
a gate layer, coupled to the low-side end,
wherein the second well of each of the plurality of pump capacitors is applied by a positive voltage when the plurality of pump capacitors are configured to generate the positive pump voltage, and the second well of each of the plurality of pump capacitors is applied by a negative voltage when the plurality of pump capacitors are configured to generate the negative pump voltage.

12-13. (canceled)

14. The method of claim 11, wherein
each of the plurality of the pump capacitors is electrically coupled between the first power supply line and the second power supply to charge each of the plurality of the pump capacitors to a predetermined voltage in a first stage, and
the plurality of the pump capacitors are coupled in series to generate the positive pump voltage or the negative pump voltage in a second stage.

15. The method of claim 14, further comprising:
switching off a plurality of the third switches to electrically insulate the plurality of the pump capacitors from one another in a first stage; and
switching on the plurality of the third switches to electrically connect the plurality of pump capacitors in series in the second stage,
wherein each of the plurality of third switches is coupled between two pump capacitors among the plurality of pump capacitors.

16. The method of claim 15, further comprising:
switching on a plurality of fourth switches to electrically connect a high-side terminal of each of the plurality of pump capacitors to the first power supply line in the first stage; and
switching off the plurality of fourth switches to electrically insulate the high-side terminal of each of the plurality of pump capacitors from the first power supply line in the second stage,
wherein the plurality of fourth switches is coupled between the plurality of pump capacitors and the first power supply.

17. The method of claim 16, further comprising:
switching on a plurality of fifth switches to electrically connect a low-side terminal of each of the plurality of pump capacitors to the second power supply line in the first stage; and
switching off the plurality of fifth switches to electrically insulate the low-side terminal of each of the plurality of pump capacitors from the second power supply line in the second stage,
wherein the plurality of fifth switches is coupled between the plurality of pump capacitors and the second power supply.

18. A charge pump device, comprising:
a plurality of pump capacitors, configured to generate a negative pump voltage or a positive pump voltage;
a first switch, coupled between a first power supply line and a first pump capacitor among the plurality of pump capacitors, configured to electrically connect the first pump capacitor to the first power supply line to generate the positive pump voltage;
a second switch, coupled between a second power supply line and a second pump capacitor among the plurality of pump capacitors, configured to electrically connect the second pump capacitor to the second power supply line to generate the negative pump voltage; and
a plurality of third switches, each of the plurality of third switches is coupled between two pump capacitors among the plurality of pump capacitors,
wherein when the first switch is switched on and the second switch is switched off, the plurality of third switches are switched on to electrically connect the plurality of pump capacitors in series, and when the first switch is switched off and the second switch is switched on, the plurality of third switches are switched on to electrically connect the plurality of pump capacitors in series.

19. The charge pump device of claim 18, wherein each of the plurality of pump capacitors comprises:
a substrate of a first semiconductor type;
a gate layer that is capacitively coupled to the second well,
a first well of a second semiconductor type, capacitively coupled to the substrate; and
a second well of the first semiconductor type, capacitively coupled to the first well,
wherein the first well is floated, the substrate is biased by a reference voltage, the second well is electrically coupled to one of the high-side terminal and the low-side terminal of the pump capacitor, and the gate layer is electrically coupled to another one of a high-side terminal and a low-side terminal of the pump capacitor.

20. The charge pump device of claim 18, wherein
each of the plurality of the pump capacitors is electrically coupled between the first power supply line and the second power supply to charge each of the plurality of the pump capacitors to a predetermined voltage in a first stage, and
the plurality of the pump capacitors are coupled in series to generate the positive pump voltage or the negative pump voltage in a second stage.
